(19) United States
(12) Patent Application Publication
(10) Pub. No.: US 2017/0018806 A1
(43) Pub. Date: Jan. 19, 2017

(54) FLAME-RESISTANT ELECTROLYTE FOR RECHARGEABLE LITHIUM SECONDARY BATTERIES AND RECHARGEABLE LITHIUM SECONDARY BATTERY INCLUDING THE SAME

(71) Applicants: Ulsan National Institute of Science and Technology, Ulsan (KR); Hyundai Motor Company, Seoul (KR)

(72) Inventors: Kyo Min SHIN, Gunpo-si (KR); Sang Heon Lee, Yongin-si (KR); Ki Seok Koh, Suwon-si (KR); Nam Soon Choi, Ulsan (KR); Sung You Hong, Ulsan (KR); Young Min Song, Ulsan (KR); Dong Seon Shin, Ulsan (KR); Choon Ki Kim, Ulsan (KR)

(73) Assignees: Hyundai Motor Company, Seoul (KR); Ulsan National Institute of Science and Technology, Ulsan (KR)

(21) Appl. No.: 14/975,337

(22) Filed: Dec. 18, 2015

(30) Foreign Application Priority Data
Jul. 16, 2015 (KR) 10-2015-0101093

(51) Int. Cl. H01M 10/0569; H01M 10/0525

(52) U.S. Cl. CPC H01M 10/0569; H01M 10/0525; H01M 2300/0037

(57) ABSTRACT

The present disclosure provides a flame-resistant electrolyte for rechargeable lithium secondary batteries, and a rechargeable lithium secondary battery including the same. The flame-resistant electrolyte for rechargeable lithium secondary batteries can reduce volatility of an organic solvent, and inhibit flammability to improve stability of a battery when a flame-resistant solvent, which includes a fluorinated phosphazene-based phosphorus compound and a phosphite-based compound for forming protective films on surfaces of negative and positive electrodes, is mixed with a lithium salt and a carbonate-based solvent, and thus has good lifespan characteristics and high battery charge/discharge efficiency even under high-temperature and high-voltage environments, and also has improved battery performance since an electrode interface is stabilized to inhibit side reaction with an electrolyte.

### CROSS-REFERENCE TO RELATED APPLICATION

The present application claims the benefit of and priority to Korean Patent Application No. 10-2015-0101093 filed on Jul. 16, 2015, which is incorporated herein by reference in its entirety.

### FIELD

The present disclosure relates to a flame-resistant electrolyte for rechargeable lithium secondary batteries and a rechargeable lithium secondary battery including the same.

### BACKGROUND

The statements in this section merely provide background information related to the present disclosure and may not constitute prior art.

In rechargeable lithium secondary batteries, materials enabling insertion and desorption of lithium ions are used as materials for negative and positive electrodes. In this case, the rechargeable lithium secondary batteries are manufactured by inserting an organic electrolyte or a polymer electrolyte between the negative electrode and the positive electrode, wherein lithium ions are movable between the negative electrode and the positive electrode. In addition, an oxidation-reduction reaction in the negative and positive electrodes occurs through insertion and desorption of lithium ions, and thus electric energy can be stored in the rechargeable lithium secondary batteries. In the case of such rechargeable lithium secondary batteries, capacity of materials for the positive and negative electrodes used in the batteries should be high, or a battery drive voltage should be enhanced so as to improve energy density. Among these methods, research and development of high-voltage positive electrode materials having similar capacity to conventional positive electrode materials but having a high drive voltage have been ardently conducted.

Materials in which some of Mn in lithium manganese oxide (LiMn₂O₄) having a spinel structure is substituted with other transition metal elements may contribute greatly to improving energy density of a battery as the battery is operated at a high voltage of 5 V. Thereamong, the most ardent research on LiNi_{0.5}Mn_{1.5}O₄ in which Mn is partially substituted with Ni has been conducted since such a lithium manganese oxide has advantages in that it can be charged and discharged at a high voltage of approximately 5 V, and has a high reversible capacity. High-voltage spinel-type manganese oxides have an average discharge voltage of 4.7 V which is very high, and may be used as a material for negative electrodes having high capacity and good safety in addition to carbon, thereby realizing high energy density, good safety, and decreased cost. Accordingly, the LiNi_{0.5}Mn_{1.5}O₄ (LNMO) is a key material for developing medium and large capacity lithium ion batteries used as power sources for next-generation vehicles. However, when an electrolyte is used under a high-voltage environment in which a battery is charged up to a voltage of 5 V, the electrolyte may be oxidatively decomposed to form a resistive layer on a surface of a positive electrode. Therefore, battery performance may be degraded due to depletion of the electrolyte.

As such, developing materials for electrolytes having good ability to withstand high-voltage environment may be a key factor for successful development of materials for high-voltage positive electrodes. In recent years, safety of batteries is also a priority in fields requiring large-capacity power sources, including electric vehicles (EVs), hybrid electric vehicles (HEVs), and plug-in hybrid electric vehicles (PHEVs).

Meanwhile, capacity of a material for positive and negative electrodes used in batteries should be high, or a battery drive voltage should be enhanced to improve energy density of a rechargeable lithium secondary battery. However, an electrolyte is oxidatively decomposed at a high voltage of 4.3 V or more to form an unstable film having inhomogeneous compositions on a surface of a positive electrode. Continuous oxidative decomposition of the electrolyte is induced since the formed film is not stably maintained in charge/discharge cycles. Such continuous decomposition reaction has some problems in that a thick resistive layer may be formed on a surface of a positive electrode, and lithium ions and electrons, both of which contribute to reversible capacity, may be consumed, resulting in a decrease in positive electrode capacity.

In addition, when elution of manganese and nickel ions from LNMO by HF formed by hydrolysis of a salt of LiPF₆ in the electrolyte is induced, a positive electrode active material may be lost, and a decrease in capacity may be caused. In this case, the eluted manganese and nickel ions may move to a surface of a negative electrode serving as a counter electrode to desorb lithium ions inserted into a graphite negative electrode, resulting in decreased cell capacity.

Since carbonate-based organic solvents have a low flash point and are highly volatile, a flame reaction may easily occur under battery abuse conditions as temperature increases. Accordingly, the organic solvents may serve as fuels in combustion of an electrode material. Such a combustion reaction of the electrolyte with the electrode material sharply increases battery temperature, which leads to thermal runaway. As the electrolyte, an ionic liquid has been used to hinder such a combustion reaction, or a flame retardant has been used to impart flame resistance. Also, since the ionic liquid is not self-extinguishable, the ionic liquid has to be mixed with the electrolyte at substantially the same content (30 vol % or more) as a co-solvent so as to impart flame resistance to the electrolyte. However, electrolyte viscosity may increase when a large amount of the ionic liquid and the flame retardant are used. In this case, the electrolyte may function as a factor inhibiting mobility of ions, degrading performance (high-rate capability) of cells.

As technology of enhancing energy density of conventional secondary batteries in which high-voltage spinel-type positive electrodes are used, Korean Unexamined Patent Publication No. 2014-0066096 discloses technology of forming a protective film on a surface of a borate-based positive electrode, and Japanese Unexamined Patent Publication No. 2009-176534 discloses technology in which a boron or phosphorus based compound is used to form a protective film for positive/negative electrodes so as to inhibit decomposition of lithium salts during a high-temperature discharge cycle.

However, in such technology, the boron or phosphorus based compound simply serves as an additive to protect a positive/negative electrode film, and thus has no influence on improving safety and performance of a secondary battery.

As described above, because most organic solvents used in organic electrolytes of commercialized lithium ion batteries are highly volatile and flammable, problems may be encountered due to thermal runaway phenomena such as battery explosion, combustion, etc.

### SUMMARY

In one form, the present disclosure provides a flame-resistant electrolyte for rechargeable lithium secondary batteries that can reduce volatility of an organic solvent, and inhibit flammability to improve battery stability when a flame-resistant solvent, which includes a fluorinated phosphazene-based phosphorus compound and a phosphite-based compound for forming protective films on surfaces of negative and positive electrodes, is mixed with a lithium salt and a carbonate-based solvent, and thus has good lifespan characteristics and high battery charge/discharge efficiency even under high-temperature and high-voltage environments, and also has improved battery performance since an electrode interface is stabilized to inhibit side reaction with an electrolyte. Therefore, the present disclosure has been completed based on these findings.

Therefore, the present disclosure provides a flame-resistant electrolyte for rechargeable lithium secondary batteries, which has improved electrochemical performance since the flame-resistant electrolyte has good lifespan characteristics and high battery charge/discharge efficiency even under high-temperature and high-voltage environments.

In another form, the present disclosure provides a rechargeable lithium secondary battery including the flame-resistant electrolyte for rechargeable lithium secondary batteries, which has improved battery performance since a surface of an electrode is stabilized to inhibit side reaction with an electrolyte.

In one aspect forms, the present disclosure provides a flame-resistant electrolyte for rechargeable lithium secondary batteries, which includes a lithium salt, a carbonate-based solvent, and a flame-resistant solvent including a phosphorus compound represented by the following Formula 1, and a phosphite-based compound:

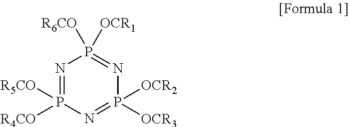

wherein R1 to R6 are independently selected from the group consisting of F₂HCH₂, FH₂CH₂, F₃CF₂CH₂, (F₃C)₂H, and F₃CF₂CF₂CH₂.

In another aspect, the present disclosure provides a rechargeable lithium secondary battery including the flame-resistant electrolyte for rechargeable lithium secondary batteries.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graph illustrating results of evaluation of flame resistance of a flame-resistant electrolyte prepared in Example 1 of the present disclosure;

FIG. 2 is a graph illustrating the results of evaluation of thermal stability of the flame-resistant electrolyte prepared in Example 1 of the present disclosure;

FIG. 3A is a graph illustrating Coulombic charge/discharge characteristics of rechargeable lithium secondary batteries manufactured using flame-resistant electrolytes for rechargeable lithium secondary batteries prepared in Example 1 and Comparative Examples 1, 2, and 3 of the present disclosure;

FIG. 3B is a graph illustrating initial Coulombic efficiency of the rechargeable lithium secondary batteries manufactured using the flame-resistant electrolytes for rechargeable lithium secondary batteries prepared in Example 1 and Comparative Examples 1, 2, and 3 of the present disclosure;

FIG. 4 is a graph illustrating results obtained by measuring impedance of positive electrode half-cells after Coulombic charging/discharging of the rechargeable lithium secondary batteries manufactured using the flame-resistant electrolytes for rechargeable lithium secondary batteries prepared in Example 1 and Comparative Examples 1, 2, and 3 of the present disclosure; and

FIG. 5 is a graph illustrating room-temperature lifespan characteristics of graphite/LNMO full-cells for the rechargeable lithium secondary batteries manufactured using the flame-resistant electrolytes for rechargeable lithium secondary batteries prepared in Examples 1 and 2 and Comparative Examples 1, 4, 5, and 6 of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a flame-resistant electrolyte for rechargeable lithium secondary batteries, which includes a lithium salt, a carbonate-based solvent, and a flame-resistant solvent including a phosphorus compound represented by the following Formula 1, and a phosphite-based compound:

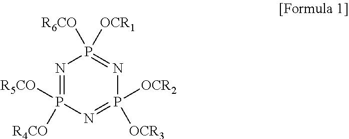

wherein R1 to R6 are independently selected from the group consisting of F₂HCH₂, FH₂CH₂, F₃CF₂CH₂, (F₃C)₂H, and F₃CF₂CF₂CH₂.

Specifically, the phosphorus compound represented by Formula 1 may serve to terminate a combustion reaction of organic substances as fluorine (F) may effectively react with active radicals (H. or C.) generated by pyrolysis of organic substances together with phosphorus (P). In addition, the F element in a structure of the compound may serve to improve high-voltage stability of the compound so that the F element may reduce a tendency to be oxidatively decomposed at a high voltage.

According to one form of the present disclosure, the flame-resistant electrolyte for rechargeable lithium secondary batteries may have characteristics of minimizing oxidative decomposition reaction of a liquid electrolyte at high voltage, improving electrochemical performance of a high-voltage positive electrode by forming a stable film (i.e., a solid electrolyte interphase (SEI) layer) on a surface of the positive electrode, and simultaneously imparting flame resistance to the electrolyte. That is, good electrochemical performance may be achieved through improvement of safety, high-voltage characteristics and lifespan characteristics of batteries to which a 5 V-class LNMO high-voltage positive electrode is applied by mixing a flame-resistant solvent including the phosphorus compound (i.e., a flame retardant) and the phosphite-based compound (i.e., a positive electrode film former).

According to another form of the present disclosure, the lithium salt used herein may include at least one selected from the group consisting of LiPF₆, LiBF₄, LiSbF₆, LiAsF₆, LiCF₃SO₃, LiN(SO₂C₂F₅)₂, Li(CF₃SO₂)₂N, LiC₄F₉SO₃, LiB(C₆H5)₄, LiClO₄, LiAlO₄, LiAlCl₄, LiN(CxF₂ₓ₊₁SO₂)(CyF_{2y+1}SO₂) (where x and y are integers), LiCl, and LiI.

According to still another form of the present disclosure, the carbonate-based solvent serves to transfer lithium ions from the positive electrode to the negative electrode or from the negative electrode to the positive electrode during a charge/discharge cycle inside a cell. In this case, the carbonate-based solvent used herein may include at least one selected from the group consisting of ethylene carbonate, ethyl methyl carbonate, dimethyl carbonate, and diethyl carbonate.

According to yet another form of the present disclosure, the flame-resistant solvent may include a phosphorus compound represented by the following Formula 1, and a phosphite-based compound. The phosphorus compound has good flame resistance as a fluorinated phosphazene-based compound, which makes it possible to realize flame retardation of the electrolyte, and serves to enhance high-rate capability and inhibit decomposition of the electrolyte in the negative electrode. In addition, the phosphite-based compound may be used to reduce oxidative decomposition of a liquid electrolyte at high voltage, and simultaneously to improve electrochemical performance of batteries, such as safety, and high voltage and lifespan characteristics by forming stables films (i.e., protective layers) on surfaces of the negative and positive electrodes.

Such a flame-resistant solvent may include 5 to 20% by weight of the phosphorus compound, and 0.1 to 2% by weight of the phosphite-based compound. Specifically, when the content of the phosphorus compound is less than 5% by weight, flame resistance may be degraded. On the other hand, when the content of the phosphorus compound is greater than 20% by weight, performance of a cell may be degraded due to increase in viscosity.

According to yet another form of the present disclosure, hexakis(2,2,2-trifluoroethoxy)cyclotriphosphazene (HTEPN) represented by the following Formula 2 may be used as the phosphorus compound.

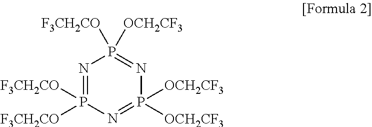

Specifically, HTEPN may be prepared by the following Scheme 1. Synthesis of a partially fluorinated phosphazene-based compound is shown in the following Scheme 1.HTEPN has a characteristic of having high contents of elements (F or P) capable of terminating a combustion reaction in one molecule.

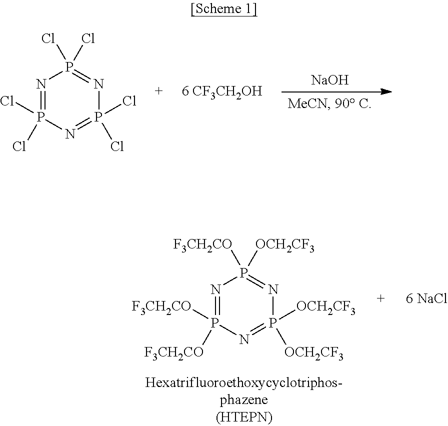

According to yet another form of the present disclosure, a phosphorus compound represented by any one of the following Formulas 3 to 7 may be used as the phosphorus compound.

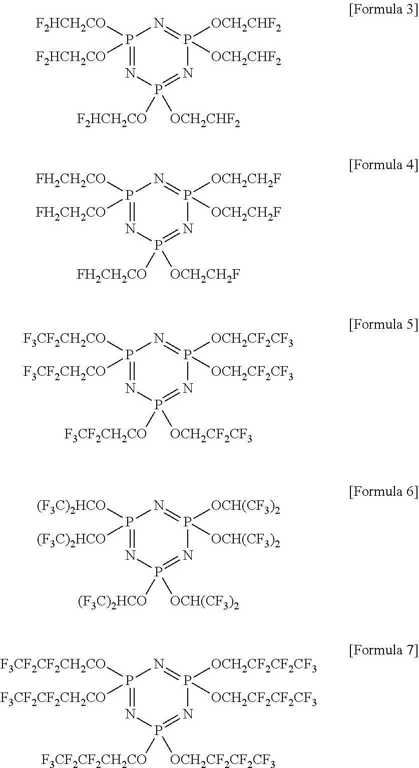

According to yet another form of the present disclosure, tris(trimethylsilyl)phosphite (TMSP) may be used as the phosphite-based compound. TMSP has a structure represented by the following Formula 8.

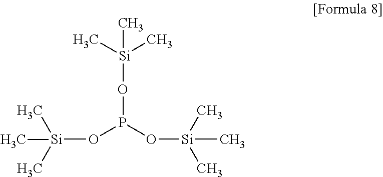

According to yet another form of the present disclosure, the flame-resistant electrolyte for rechargeable lithium secondary batteries may include 15 to 25% by weight of the lithium salt, 65 to 84% by weight of the carbonate-based solvent, and 1 to 10% by weight of the flame-resistant solvent. Specifically, when the content of the flame-resistant solvent is less than 1% by weight, it is impossible to expect a flame-retardant effect. On the other hand, when the content of the flame-resistant solvent is greater than 10% by weight, cell performance may be degraded due to side reaction and increase in viscosity.

According to yet another form of the present disclosure, the flame-resistant electrolyte for rechargeable lithium secondary batteries may further include 1 to 5% by weight of a film former, based on 100% by weight of the flame-resistant electrolyte. Specifically, when the content of the film former is less than 1% by weight, cell performance may be degraded. On the other hand, when the content of the film former is greater than 5% by weight, side reaction with the electrolyte may occur in an interface of an electrode. The film former may be a negative electrode film former. Fluorine ethylene carbonate (FEC), vinyl carbonate (VC), or a mixture thereof may be used as such a film former.

Meanwhile, the present disclosure provides a rechargeable lithium secondary battery including the flame-resistant electrolyte for rechargeable lithium secondary batteries.

Therefore, the flame-resistant electrolyte for rechargeable lithium secondary batteries according to a form of the present disclosure can reduce volatility of an organic solvent, and inhibit flammability to improve battery stability (to impart flame resistance) when a flame-resistant solvent, which includes a fluorinated phosphazene-based phosphorus compound and a phosphite-based compound for forming protective films on surfaces of negative and positive electrodes, is mixed with a lithium salt and a carbonate-based solvent, and thus has good lifespan characteristics and high charge/discharge efficiency of battery even under high-temperature and high-voltage environments, thereby improving electrochemical performance.

In addition, an interface of an electrode can be stabilized by stably protecting a surface of a positive or negative electrode as well as imparting a flame resistance function to the electrolyte, thereby inhibiting side reaction with the electrolyte and improving battery performance (battery capacity, and lifespan characteristics).

Hereinafter, one or more forms of the present disclosure will be described in detail with reference to the following examples. However, these examples are not intended to limit the purpose and scope of the one or more forms of the present disclosure.

The following examples illustrate the disclosure and are not intended to limit the same.

### EXAMPLE 1

Preparation of HTEPN Compound

A phosphonitrilic chloride trimer (4 g, 11.505 mmol, 1 eq.), 2,2,2-trifluoroethanol (8 g, 79.968 mmol, 7 eq.), and sodium hydroxide (4.6 g, 115.0 mmol, 10 eq.) were mixed with acetonitrile (350 mL), and the resulting mixture was reacted at 90° C. for 24 hours under reflux. The resulting solid powder was filtered, again dissolved in diethyl ether (70 mL), washed with a 1 M NaOH solution (50 mL) and saline (50 mL), and then dried to obtain HTEPN in the form of a powder.

(2) Manufacture of Flame-Resistant Electrolyte for Rechargeable Lithium Secondary Batteries

5.5% by weight of a flame-resistant solvent (including 5% by weight of HTEPN prepared by the method, and 0.5% by weight of TMSP), 18% by weight of LiPF₆ (1 M), and 76.5% by weight of a mixed solvent including ethylene carbonate, ethyl methyl carbonate and dimethyl carbonate (in a volume ratio of 30:40:30) were mixed to manufacture a flame-resistant electrolyte for rechargeable lithium secondary batteries.

### EXAMPLE 2

A flame-resistant electrolyte for rechargeable lithium secondary batteries was manufactured in the same manner as in Example 1, except that 5% by weight of FEC was further added.

### COMPARATIVE EXAMPLE 1

A flame-resistant electrolyte for rechargeable lithium secondary batteries was manufactured in the same manner as in Example 1, except that only a lithium salt (LiPF₆) and a mixed solvent including ethylene carbonate, ethyl methyl carbonate and dimethyl carbonate (at a volume ratio of 30:40:30) were mixed instead of the flame-resistant solvent.

### COMPARATIVE EXAMPLE 2

A flame-resistant electrolyte for rechargeable lithium secondary batteries was manufactured in the same manner as in Example 1, except that trimethyl phosphate (TMP) was mixed instead of the flame-resistant solvent.

### COMPARATIVE EXAMPLE 3

A flame-resistant electrolyte for rechargeable lithium secondary batteries was manufactured in the same manner as in Example 1, except that dimethyl methylphosphonate (DMMP) was mixed instead of the flame-resistant solvent.

### COMPARATIVE EXAMPLE 4

A flame-resistant electrolyte for rechargeable lithium secondary batteries was manufactured in the same manner as in Example 1, except that TMSP was mixed alone instead of the flame-resistant solvent.

### COMPARATIVE EXAMPLE 5

A flame-resistant electrolyte for rechargeable lithium secondary batteries was manufactured in the same manner as in Example 1, except that HTEPN was mixed alone instead of the flame-resistant solvent.

### COMPARATIVE EXAMPLE 6

A flame-resistant electrolyte for rechargeable lithium secondary batteries was manufactured in the same manner as in Example 1, except that VC was mixed instead of the flame-resistant solvent.

### TEST EXAMPLE 1

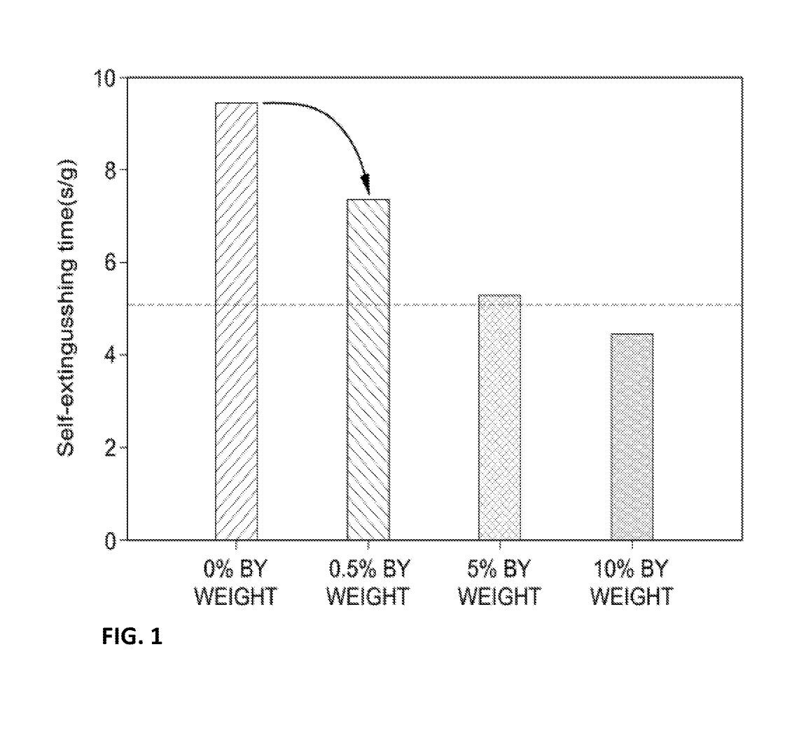

A flame resistant test was performed on the flame-resistant electrolyte used in Example 1. The results are listed in the following Table 1, and shown in FIG. 1. Specifically, HTEPN in the flame-resistant solvent of Example 1 was added in amounts of 0, 0.5, 5, and 10% by weight, and a flame resistance test was then performed on the flame-resistant electrolyte.

TABLE 1
Self-extinguishing time (sec/g)

| | |
|---|---|
| 0% by weight of HTEPN | 9.48 sec/g |
| 0.5% by weight of HTEPN | 7.37 sec/g |
| 5% by weight of HTEPN | 5.31 sec/g |
| 10% by weight of HTEPN | 4.48 sec/g |

Based on the results listed in Table 1 and shown in FIG. 1, when HTEPN was added in an amount of 0, and 0.5% by weight, the electrolyte was flammable since the electrolyte had a self-extinguishing time of 5 seconds or more, and when HTEPN was added in amounts of 5 and 10% by weight, the electrolyte was flame-resistant since the electrolytes had a self-extinguishing time of 5.31 seconds and 4.48 seconds, respectively, thereby realizing flame retardation of the electrolyte. In this case, the results showed that a flame resistance effect was expressed due to an increase in content of elements (F or P) capable of terminating a combustion reaction in one molecule.

FIG. 1 is a graph illustrating the results of evaluation of flame resistance of the flame-resistant electrolyte prepared in Example 1.

### TEST EXAMPLE 2

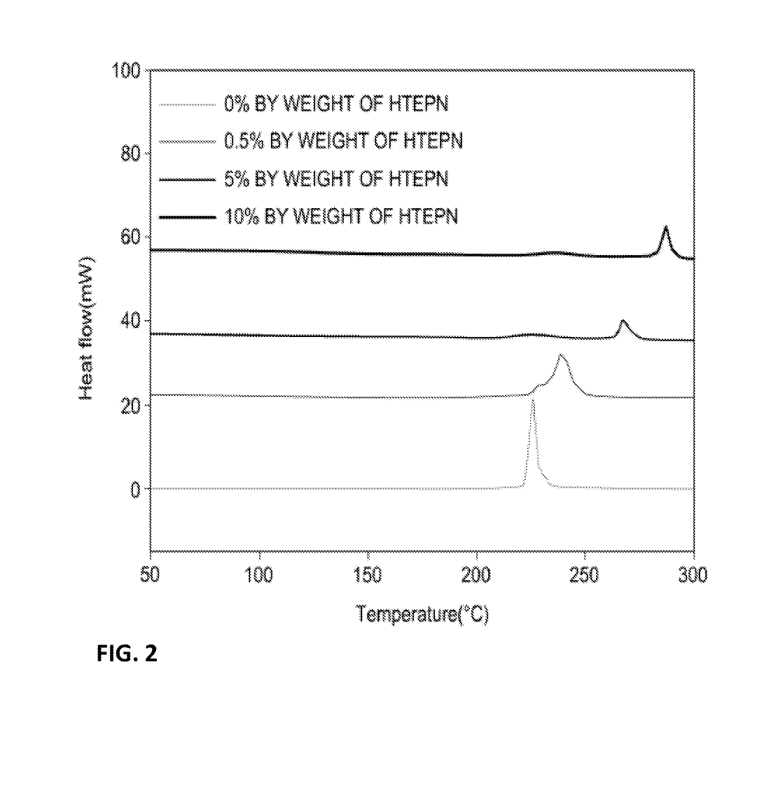

A thermal stability test (i.e., a differential scanning calorimetry (DSC) test) was performed on the flame-resistant electrolyte used in Example 1. The results are listed in the following Table 2 and shown in FIG. 2. Specifically, HTEPN in the flame-resistant solvent of Example 1 was added in amounts of 0, 0.5, 5, and 10% by weight, and a thermal stability test was then performed on the flame-resistant electrolyte.

TABLE 2

| | Onset | |
|---|---|---|
| Items | temperature | ΔH |
| 0% by weight of HTEPN | 226.6 w | 499.5 J/g |
| 0.5% by weight of HTEPN | 239.7by | 565.0 J/g |
| 5% by weight of HTEPN | 268.0 w | 138.0 J/g |
| 10% by weight of HTEPN | 286.1 y | 203.4 J/g |

Based on the results listed in Table 2, it could be seen that an onset temperature increased and a heating value decreased by 50% or more when the amounts of added HTEPN were 5 and 10% by weight, respectively, compared to when the amounts of added HTEPN were 0 and 0.5% by weight, indicating that the flame-resistant electrolyte had superior flame resistance when the amounts of added HTEPN were 5 and 10% by weight, compared to when the amounts of added HTEPN were 0 and 0.5% by weight.

FIG. 2 is a graph illustrating the results of evaluation of thermal stability of the flame-resistant electrolyte prepared in Example 1. As shown in FIG. 2, it could be seen that expression of exothermic peaks was delayed when the amounts of added HTEPN were 5 and 10% by weight, compared to when the amounts of added HTEPN were 0 and 0.5% by weight.

From these findings, it could be seen that that a flame resistance effect was enhanced due to an increase in content of elements (F or P) capable of terminating a combustion reaction in one molecule, like in Test Example 1.

### TEST EXAMPLE 3

Rechargeable lithium secondary batteries were manufactured using the flame-resistant electrolytes for rechargeable lithium secondary batteries prepared in Examples 1 and 2 and Comparative Examples 1 to 6, as follows.

Specifically, poly(vinylidene fluoride) (PVdF) used as a binder for positive electrode was completely dissolved in N-methylpyrrolidone, and a conductive material, Super P carbon, and a positive electrode active material, LiNi_{0.5}Mn_{1.5}O₄, were then mixed with the resulting binder solution. In this case, the positive electrode active material, the conductive material, and the binder were mixed in a weight ratio of 90:5:5. Next, a slurry solution in which such components were completely mixed was coated onto aluminum foil, and dried, and a lamination process was performed using a roll press. Here, the lamination process was performed to improve binding force between the active material, the conductive material and the binder and to effectively bind these components to a current collector. When a compression process was completed, sheets of positive electrodes with proper size were prepared through a cutting procedure, and dried at 110° C. for 24 hours or more in a vacuum oven to manufacture positive electrodes. Thereafter, coin cells were manufactured from the resulting positive electrodes using a conventional method. A lithium metal laminated on copper foil was used as a negative electrode, each of the flame-resistant electrolytes prepared in Examples 1 and 2 and Comparative Examples 1 to 7 was used as an electrolyte, and a polyethylene separation film was used as a separation film. All the electrodes were prepared in a dry room, and the batteries were manufactured in a glove box which was maintained under an argon atmosphere. The manufactured cells were repeatedly charged and discharged at a current density of 0.5 C in a voltage range of 3.5 to 5.0 V.

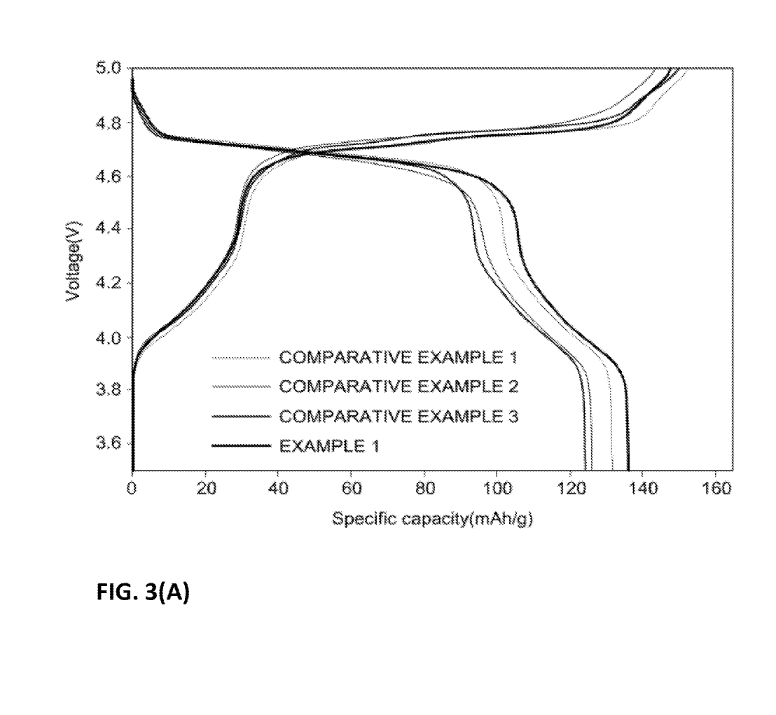

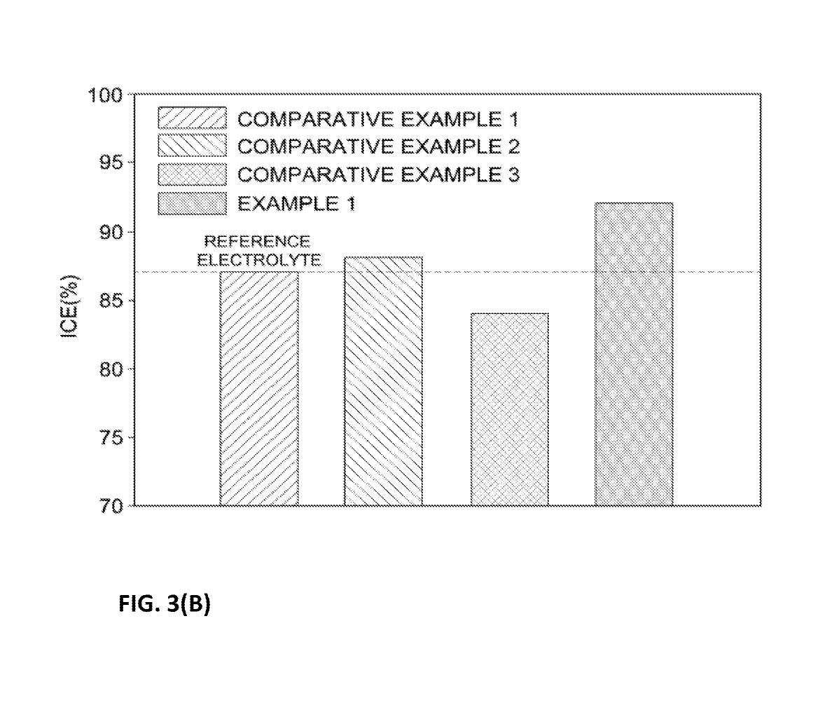

Coulombic charge/discharge characteristics of the rechargeable lithium secondary batteries manufactured using the flame-resistant electrolytes rechargeable lithium secondary batteries prepared in Example 1 and Comparative Examples 1, 2, and 3 were evaluated by means of a formation process. Results are shown in FIGS. 3A and 3B.

FIG. 3A is a graph illustrating Coulombic charge/discharge characteristics of the rechargeable lithium secondary batteries manufactured using the flame-resistant electrolytes for rechargeable lithium secondary batteries prepared in Example 1 and Comparative Examples 1, 2, and 3. As shown in FIG. 3A, it could be seen that the rechargeable lithium secondary batteries in Comparative Examples 1, 2 and 3 had capacities of 125, 124, and 132 mAh/g, respectively, and the rechargeable lithium secondary battery had a relatively high capacity of 138 mAh/g in the case of Example 1, indicating that the charge/discharge characteristics were improved.

FIG. 3B is a graph illustrating initial Coulombic efficiency of the rechargeable lithium secondary batteries manufactured using the flame-resistant electrolytes for rechargeable lithium secondary batteries prepared in Example 1 and Comparative Examples 1, 2, and 3, as measured by means of a formation process. As shown in FIG. 3B, it could be seen that the rechargeable lithium secondary batteries in Comparative Examples 1, 2 and 3 had initial Coulombic efficiencies of approximately 88, 84, and 87%, respectively. In this case, it was revealed that, in the case of Comparative Examples 1 and 2 in which the flame-resistant electrolytes included the TMP and DMMP compounds, respectively, the rechargeable lithium secondary batteries had an initial Coulombic efficiency similar to or lower than that of Comparative Example 3 in which a reference electrolyte was used.

On the other hand, it was revealed that the initial Coulombic efficiency of the rechargeable lithium secondary battery was improved by approximately 94% in the case of Example 1. Therefore, it was revealed that the rechargeable lithium secondary battery had a higher initial Coulombic efficiency, compared to those of rechargeable lithium secondary batteries in Comparative Example 3 in which the conventional reference electrolyte was used, and Comparative Examples 1 and 2 in which the flame-resistant electrolytes included the TMP and DMMP compounds having flame resistance, respectively. As a result, it could be seen that flame resistance of the electrolyte was enhanced, and capacity and initial performance of the secondary battery were improved.

### TEST EXAMPLE 4

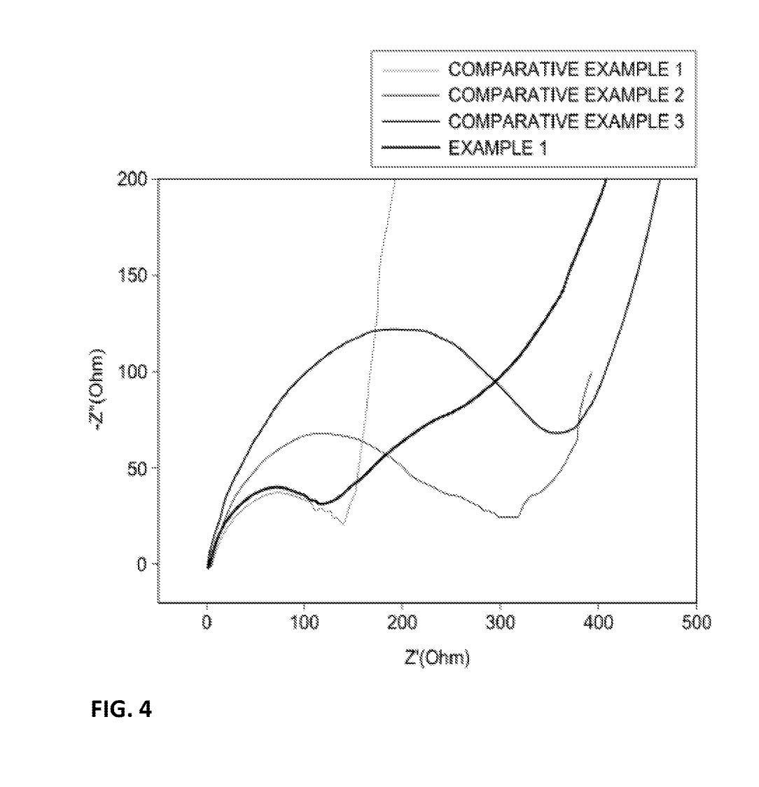

Impedance of positive electrode half-cells after Coulombic charging/discharging of the rechargeable lithium secondary batteries manufactured using the flame-resistant electrolytes prepared in Example 1 and Comparative Examples 1, 2, and 3 was measured. Results are shown in FIG. 4.

FIG. 4 is a graph illustrating results obtained by measuring impedance of positive electrode half-cells after Coulombic charging/discharging of the rechargeable lithium secondary batteries manufactured using the flame-resistant electrolytes for rechargeable lithium secondary batteries prepared in Example 1 and Comparative Examples 1, 2, and 3. As shown in FIG. 4, it could be seen that the battery capacity was reduced since transfer of lithium ions was not easily achieved due to high interface resistance in the case of Comparative Examples 1 and 2, as verified in Test Example 3.

On the other hand, it could be seen that, in the case of Example 1 in which the flame-resistant electrolyte included the flame-resistant solvent including the phosphorus compound and the phosphite-based compound, the rechargeable lithium secondary battery had lower interface resistance than that of Comparative Example 3 in which the reference electrolyte was used, indicating that a film formed on a surface of the positive electrode using the flame-resistant solvent had lower resistance, compared to that of Comparative Example 3. As a result, it could be seen that lithium ions and electrons were easily transferred through the film formed on the surface of the LNMO positive electrode. In addition, it could be seen that the flame-resistant solvent showed a flame resistance function, and also effectively inhibited side reaction with the electrolyte by forming a film on a surface of the positive electrode, leading to improvement of battery performance (battery capacity and lifespan characteristics).

### TEST EXAMPLE 5

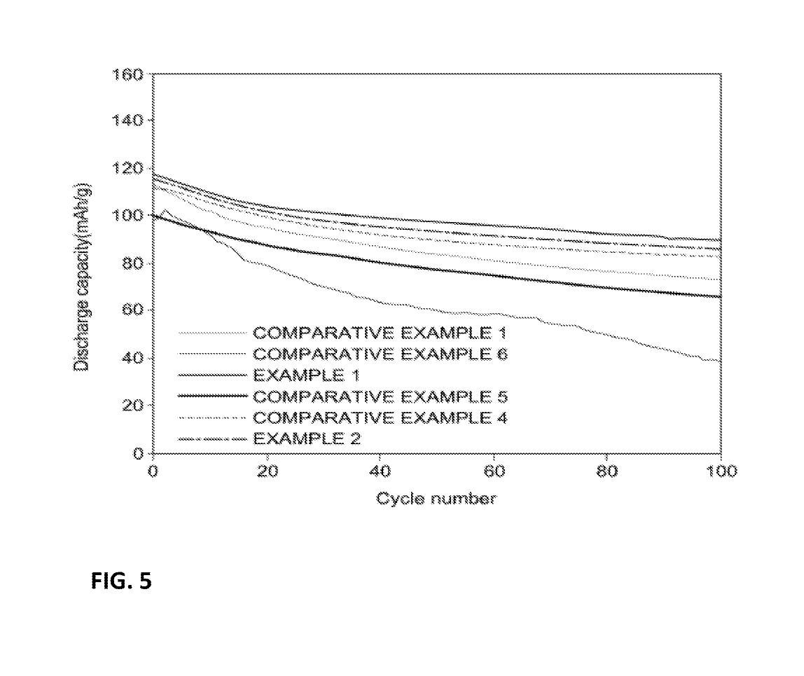

Room-temperature lifespan characteristics of graphite/LNMO full-cells for the rechargeable lithium secondary batteries manufactured using the flame-resistant electrolytes for rechargeable lithium secondary batteries prepared in Examples 1 and 2 and Comparative Examples 1, 4, 5, and 6 were evaluated. Results are shown in FIG. 5. Such evaluation was performed to determine characteristics of the electrolyte. When both lifespan characteristics of positive electrode half-cells and performance of negative electrode half-cells were satisfactory, degradation of performance of the secondary battery may be prevented.

FIG. 5 is a graph illustrating room-temperature lifespan characteristics of graphite/LNMO full-cells for the rechargeable lithium secondary batteries manufactured using the flame-resistant electrolytes for rechargeable lithium secondary batteries prepared in Examples 1 and 2 and Comparative Examples 1, 4, 5, and 6. As shown in FIG. 5, it could be seen that an interface of the negative electrode was stabilized to enhance discharge capacity, but flame resistance was degraded in the case of Comparative Example 4 in which the TMSP compound was added alone.

In addition, the rechargeable lithium secondary battery had very low discharge capacity characteristics in the case of Comparative Example 5 in which the HTEPN compound was added alone, indicating that affinity between the HTEPN compound and the graphite negative electrode was very low. As a result, it could be seen that a negative electrode film formed by reductive decomposition of the flame retardant degraded electrochemical performance of the negative electrode.

Further, it could be seen that the discharge capacity was drastically degraded with an increase in the number of charge/discharge cycles, or was very low in the case of Comparative Example 1 and 6 in which the flame-resistant solvent was not added and VC was added instead of the flame-resistant solvent. As a result, it could be seen that lifespan of the battery was shortened due to degradation of the battery as a stable film (SEI) was not formed on a surface of the positive electrode.

On the other hand, it could be seen that the rechargeable lithium secondary batteries showed stable lifespan characteristics even with an increasing number of charge/discharge cycles in the case of Example 1 in which the flame-resistant electrolytes included the HTEPN compound and the TMSP compound, and Example 2 in which FEC was further added as the film former. Particularly, it could be seen that the TMSP compound stabilized the interface of the negative electrode to improve lifespan characteristics, and also imparted flame resistance through addition of the HTEPN compound to improve battery performance. In addition, it was revealed that the rechargeable lithium secondary batteries had a high discharge capacity maintenance rate since a film was formed on the negative electrode by adding FEC as the film former so as to inhibit side reaction.

Therefore, the flame-resistant electrolytes for rechargeable lithium secondary batteries prepared in Examples 1 and 2 can reduce volatility of an organic solvent, and inhibit flammability to improve stability of a battery (to impart flame resistance) when a flame-resistant solvent, which includes a fluorinated phosphazene-based phosphorus compound and a phosphite-based compound for forming protective films on surfaces of negative and positive electrodes, is mixed with a lithium salt and a carbonate-based solvent, and thus have good lifespan characteristics and high battery charge/discharge efficiency even under high-temperature and high-voltage environments, thereby improving electrochemical performance.

In addition, an interface of the electrode can be stabilized by stably protecting a surface of the positive or negative electrode as well as imparting a flame resistance function to the electrolyte, thereby inhibiting a side reaction with the electrolyte and improving battery performance (battery capacity, and lifespan characteristics).

The flame-resistant electrolytes for rechargeable lithium secondary battery according to a form of the present disclosure can reduce volatility of an organic solvent, and inhibit flammability to improve stability of a battery when a flame-resistant solvent, which includes a fluorinated phosphazene-based phosphorus compound and a phosphite-based compound for forming protective films on surfaces of negative and positive electrodes, is mixed with a lithium salt and a carbonate-based solvent, and thus has good lifespan characteristics and high battery charge/discharge efficiency even under high-temperature and high-voltage environments, thereby improving electrochemical performance.

In addition, an interface of the electrode can be stabilized by stably protecting a surface of the positive or negative electrode as well as imparting a flame resistance function to the electrolyte, thereby inhibiting side reaction with the electrolyte and improving battery performance (battery capacity, and lifespan characteristics).

The disclosure has been described in detail with reference to forms thereof. However, it will be appreciated by those skilled in the art that changes may be made in these forms without departing from the principles and spirit of the disclosure, the scope of which is defined in the appended claims and their equivalents.

What is claimed is:

1. A flame-resistant electrolyte for rechargeable lithium secondary batteries comprising:
a lithium salt;
a carbonate-based solvent; and
a flame-resistant solvent comprising a phosphorus compound represented by the following Formula 1, and a phosphite-based compound. 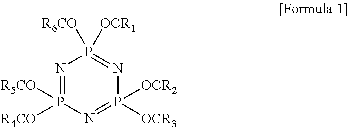
wherein R1 to R6 are selected from the group consisting of F₂HCH₂, FH₂CH₂, F₃CF₂CH₂, (F₃C)₂H, and F₃CF₂CF₂CH₂.

2. The flame-resistant electrolyte of claim 1, wherein the lithium salt comprises at least one selected from the group consisting of LiPF₆, LiBF₄, LiSbF₆, LiAsF₆, LiCF₃SO₃, LiN(SO₂C₂F₅)₂, Li(CF₃SO₂)₂N, LiC₄F₉SO₃, LiB(C₆H₅)₄, LiClO₄, LiAlO₄, LiAlCl₄, LiN(CₓF₂ₓ₊₁SO₂)(CyF_{2y+1}SO₂) (where x and y are integers), LiCl, and LiI.

3. The flame-resistant electrolyte of claim 1, wherein the carbonate-based solvent comprises at least one carbonate selected from the group consisting of ethylene carbonate, ethyl methyl carbonate, dimethyl carbonate, and diethyl carbonate.

4. The flame-resistant electrolyte of claim 1, wherein the flame-resistant solvent comprises 5 to 20% by weight of the phosphorus compound, and 0.1 to 2% by weight of the phosphite-based compound.

5. The flame-resistant electrolyte of claim 1, wherein the phosphorus compound is a hexakis(2,2,2-trifluoroethoxy)cyclotriphosphazene (HTEPN) compound represented by the following Formula 2.

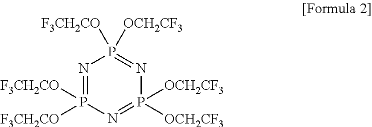

6. The flame-resistant electrolyte of claim 1, wherein the phosphorus compound is a phosphorus compound selected from the group of Formulas 3 to 7 consisting of:

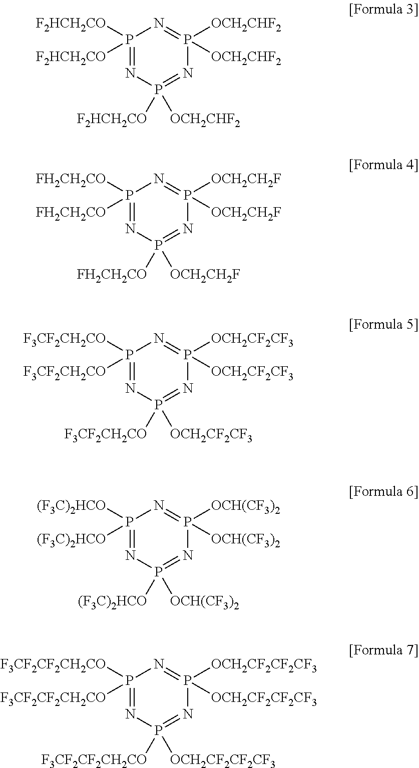

7. The flame-resistant electrolyte of claim 1, wherein the phosphite-based compound is a tris(trimethylsilyl)phosphite (TMSP) compound.

8. The flame-resistant electrolyte of claim 1, wherein the flame-resistant electrolyte for rechargeable lithium secondary batteries comprises 15 to 25% by weight of the lithium salt, 65 to 84% by weight of the carbonate-based solvent, and 1 to 10% by weight of the flame-resistant solvent.

9. The flame-resistant electrolyte of claim 1, further comprising 1 to 5% by weight of a film former, based on 100% by weight of the flame-resistant electrolyte.

10. The flame-resistant electrolyte of claim 9, wherein the film former is fluorine ethylene carbonate (FEC), vinyl carbonate (VC), or a mixture thereof.

11. A rechargeable lithium secondary battery comprising the flame-resistant electrolyte for rechargeable lithium secondary batteries defined according to claim 1.
